(19) United States
(12) Patent Application Publication
(10) Pub. No.: US 2018/0242761 A1
(43) Pub. Date: Aug. 30, 2018

(54) SHELF MOUNTING STRUCTURE INDICATION

(71) Applicant: Wal-Mart Stores, Inc., Bentonville, AR (US)

(72) Inventors: Nicholaus A. Jones, Fayetteville, AR (US); Matthew A. Jones, Bentonville, AR (US)

(21) Appl. No.: 15/881,995

(22) Filed: Jan. 29, 2018

Related U.S. Application Data
(60) Provisional application No. 62/464,462, filed on Feb. 28, 2017.

(51) Int. Cl. A47F 11/10; A47F 5/10; G08B 5/36

(52) U.S. Cl. CPC A47F 11/10; G08B 5/36; A47F 5/103

(57) ABSTRACT

In some embodiments, apparatuses and methods are provided herein useful to quickly and accurately determine a height for mounting shelves to a shelving unit. More specifically, a visual indication of a correct mounting height for the shelves is provided to aid in assembly and subsequent inspection of the shelving unit. Pursuant to this, light sources are mounted adjacent to mounting structures of the shelving unit and are configured to selectively illuminate next to mounting structures intended to have a shelf mounted thereto.

### CROSS-REFERENCE TO RELATED APPLICATION

This application claims the benefit of U.S. Provisional Application No. 62/464,462, filed Feb. 28, 2017, which is incorporated by reference in its entirety herein.

### TECHNICAL FIELD

This invention relates generally to modular shelving units and, more particularly, to systems for mounting shelving to modular shelving units.

### BACKGROUND

Retail stores often utilize modular shelving units to display products for sale. These modular shelving units can include notches along the height of back plate to mount shelves at desired heights. In many cases, a retail store has a plan setting out specific height locations for each shelf of the modular display units. A worker installing the shelves, however, may not follow the plan due to simple error or based on getting easier access to the products on the shelves, for example. These revisions to the plan can result in non-uniform displays that detract from the overall appearance of an aisle and can potentially cause the modular shelving unit height to exceed a preset maximum. Determining whether a modular shelving unit was installed according to the plan, however, can be a difficult and timely process.

### BRIEF DESCRIPTION OF THE DRAWINGS

Disclosed herein are embodiments of systems, apparatuses and methods pertaining to assembly and evaluation of shelving units. This description includes drawings, wherein:

FIG. 1 is a perspective view of a shelving unit in accordance with some embodiments.

FIG. 2 is a system diagram in accordance with several embodiments.

FIG. 3 is a sectional view of a cradle, light sources, and mounting structures of a shelving unit in accordance with some embodiments.

FIG. 4 is a diagrammatic view of an electronic assembly in accordance with several embodiments.

FIG. 5 is a flowchart in accordance with some embodiments.

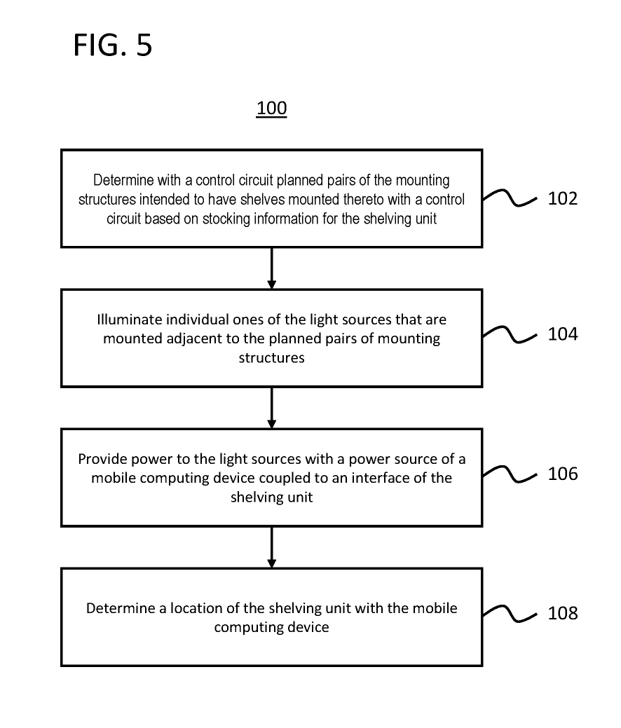

FIG. 6 is a flowchart in accordance with several embodiments.

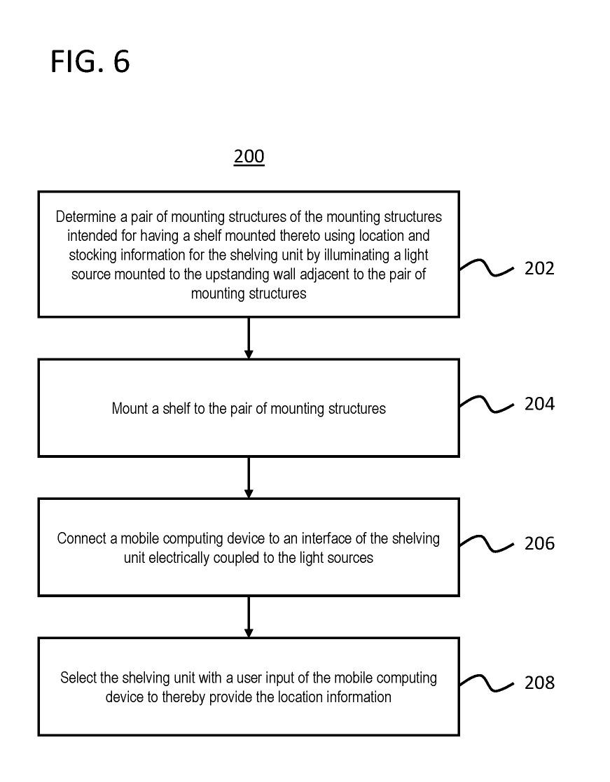

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to quickly and accurately determine a height for mounting shelves to a shelving unit. This is particularly advantageous to determine whether shelves in the shelving unit were installed at the correct height and/or for installing shelves at desired heights.

The system includes visually indicating which mounting structures of a shelving unit are intended, such as according to a modular plan for a retail store, to have shelves mounted thereto. By some approaches, the visual indication is provided by light sources mounted adjacent to the mounting structures. A control circuit analyzes the modular plan and illuminates the light sources that are mounted adjacent to the mounting structures intended to have shelves mounted thereto. In several forms, the control circuit is mobile and selectively coupled to the shelving unit.

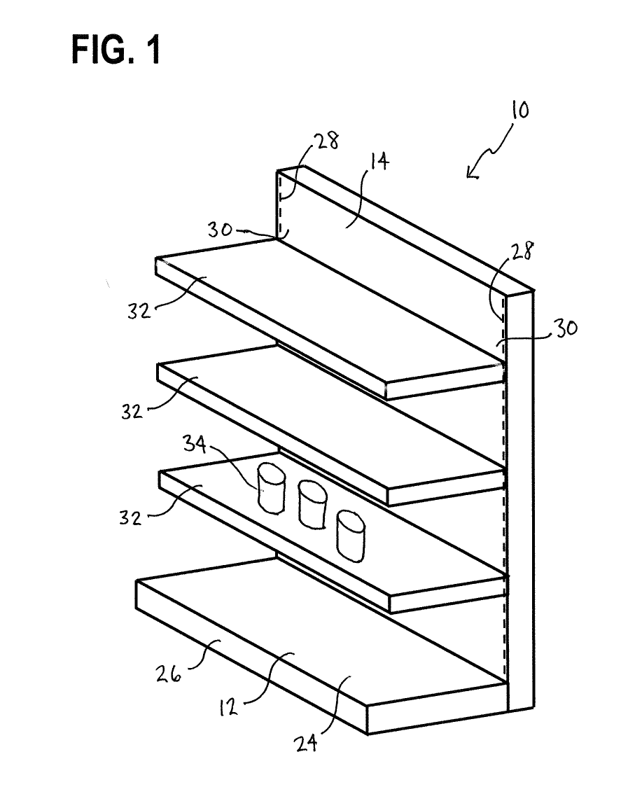

One example modular shelving unit 10 is shown in FIG. 1. Based on a particular use, multiple shelving units 10 can be aligned in a row to produce an aisle in a retail location. The shelving unit 10 includes a base portion 12 and a back wall 14 extending upwardly therefrom. The base portion 12 can include a base deck 24 and a kick plate 26, as commonly configured.

The shelving unit 10 further includes mounting structures 28 disposed at least adjacent to lateral edge portions 30 of the back wall 14. The mounting structures 28 can take any suitable form for mounting shelves 32 to the back wall 14. The mounting structures 28 cooperate with complementary structures on the shelves 32. In the illustrated form, the mounting structures 28 are shelf notches that are vertically disposed adjacent to the lateral edge portions 30 of the back wall 14 that provide anchor points for projecting portions of shelves 32 to be received therein to thereby mount the shelves 32 to the shelving unit 10. Of course, other structures, such as hooks, clamps, fasteners, or the like, disposed on either the back wall 14 or shelves 32 as desired, can also be utilized. Further, the mounting structures 28 can be incorporated into the back wall 14 or can be provided by a separate strip or plate mounted to the back wall 14 as desired.

As shown in FIG. 1, the mounting structures 28 begin at a height above the base portion 12. As such, the mounting structures 28 cannot be easily identified by traditional measuring sticks or tape measures. Instead, a user is forced to manually count the structures 28 to determine a desired height, which can easily lead to mistakes. Rather than following a modular plan as to the desired height of the shelves on the shelving unit 10, a user may use a product 34 that is intended for the shelf 32 to set the shelf height at a convenient location above the product 34. This practice, however, can undesirably lead to shelves 32 being mounted to mounting structures 28 that are not identified in the preset plan, which can also lead to shelves 32 being mounted above desired height limits. Additionally, due to the location of the mounting structures 28 along the back wall 14, it can be difficult for a user to subsequently check the height of shelves 32 already mounted to the shelving unit 10, especially due to the height of the base portion 12.

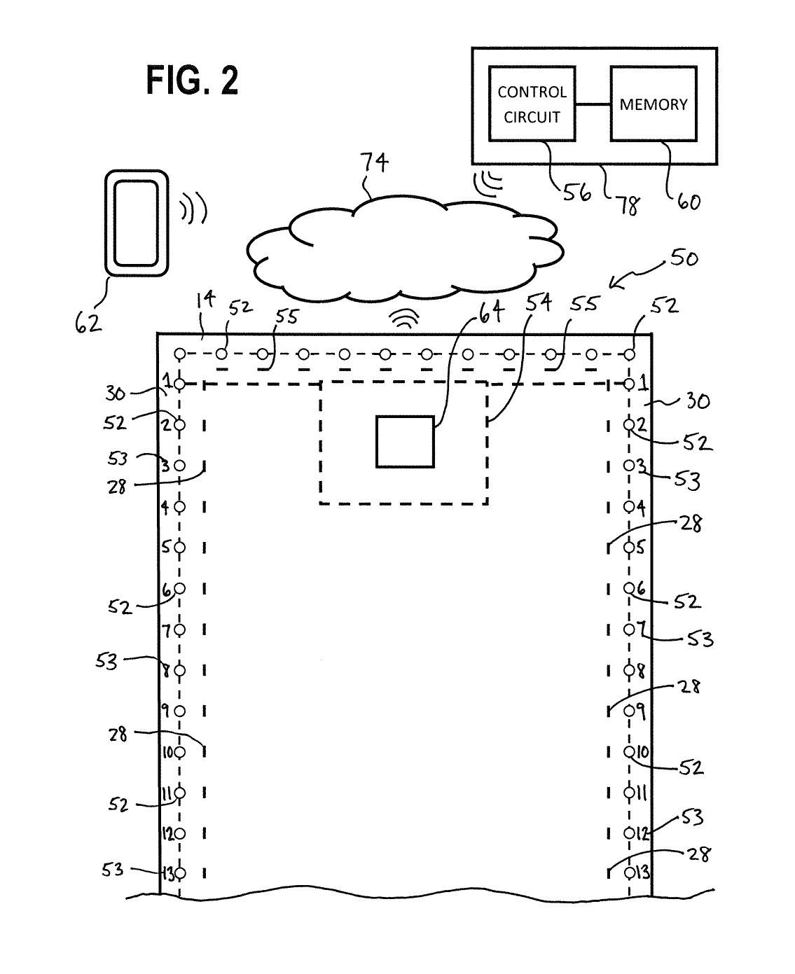

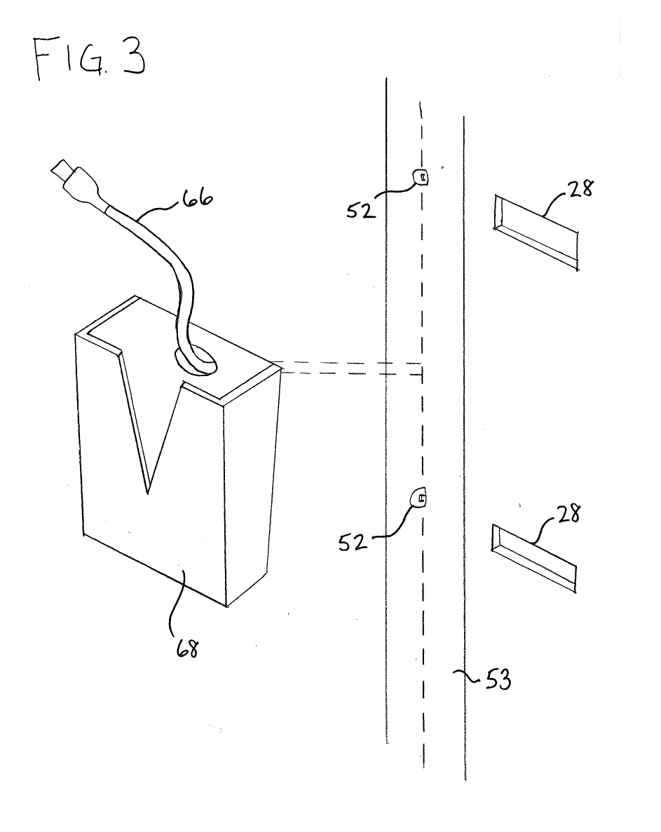

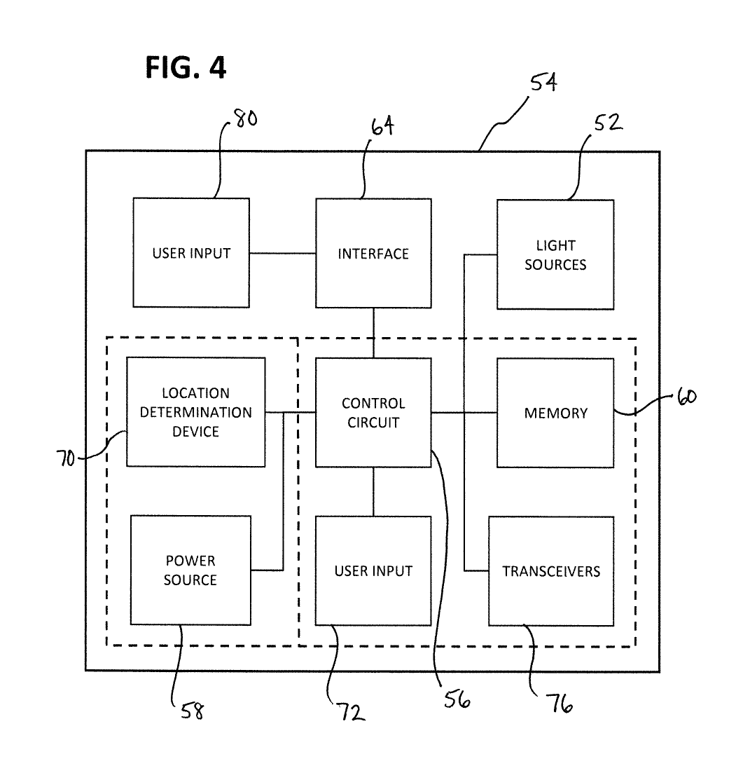

Solving these problems, a system 50 for indicating shelf mounting height for the shelving unit 10 is shown in FIGS. 2-4. The system 50 provides a visual indication of a planned mounting height for the shelves 32 to aid in assembly and subsequent inspection of the shelving unit 10. Pursuant to this, the system 50 includes light sources 52, such as light emitting diodes, mounted adjacent to each of the mounting structures 28, where individual ones of the light sources 52 are configured, as described in more detail below, to selectively illuminate next to mounting structures 28 intended to have a shelf 32 mounted thereto. By a first approach, the light sources 52 can be mounted and wired directly to or within the back wall 14. By a second approach, the light sources 52 can be incorporated into an elongate strip 53 sized to space the light sources 52 apart from one another to generally align with the mounting structures 28 when the strip 53 is secured or adhered to the back wall 14. Further, the light sources 52 can be disposed on one or both of the lateral edge portions 30 of the back wall 14, as desired.

So configured, when an associate is mounting the shelves 32 to the back wall 14, illuminated light sources 52 provide an easy visual indication of where to mount the shelves 32. Similarly, when an associate is checking the height of shelves 32 already mounted to the back wall 14, illuminated light sources 52 provide an easy visual indication of whether the shelves 32 are mounted at the correct heights. By some approaches, the light sources 52 are mounted to the back wall 14 outwardly of the mounting structures 28 so that the light sources 52 are easily visible when shelves 32 are being mounted to or are mounted thereto. By further or other approaches, the light sources 52 can be offset from the adjacent mounting structures 28, so that the light sources 52 are not covered by a shelf 32 mounted to the mounting structures 28.

If desired, the mounting structures 28 can further include associated numbering 53 to supplement the light sources 52. For example, the mounting structures 28 can be numbered starting from the bottom or top one thereof. So configured, an associate can double check that the illuminated light sources 52 are adjacent to a number 53 that is indicated in the modular plan. By one approach, the numbering 53 can be transparent or translucent and disposed at least partially over the light sources 52 so that when the light sources 52 are selectively illuminated, the associated number 53 is also illuminated.

Although the 50 is described herein with regard to vertically spaced mounting structures 28, the system 50 can also be utilized for horizontally spaced structures 55, such as holes on a peg board 14 or the like, for reception of hooks or rods for hanging products. In such embodiments, the system 50 will illuminate light sources 52 vertically aligned with the structures 55 that are planned to have the hooks or rods mounted thereto. These embodiments can be utilized with any of the below configurations.

The system 50 includes an electronic assembly 54, which includes the light sources 52, a control circuit 56, a power source 58, and a memory 60 having modular and stocking information stored thereon. The modular and stocking information includes shelving unit location information and shelf height plans for the individual shelving units 10 with corresponding pairs of mounting structures 28 planned to have a shelf 32 mounted thereto. So configured, the control circuit 56 controls power flow from the power source 58 to selected ones of the light sources 52 according to the modular and stocking information stored in the memory 60. Various embodiments distributing the components of the electronic assembly 54 are described below. It will be understood, however, that each of the devices described includes additional components for operation, such as processors, electrical pathways, e.g., wires, traces, pins, etc., connecting the components, and so forth.

The term control circuit refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 56 may be configured (for example, by using corresponding programming stored in a memory as will be well understood by those skilled in the art) to carry out one or more of the steps, actions, and/or functions described herein.

In some embodiments, the system 50 includes a mobile computing device 62, such as a tablet, mobile phone, or the like, that an associate moves or carries from shelving unit 10 to shelving unit 10 to determine the shelf mounting heights planned therefor. The mobile computing device 62 can advantageously incorporate components of the electronic assembly 54, such that the shelving units 10 can have a less complicated and less expensive configuration. In such a configuration, each shelving unit 10 includes an interface 64 configured to couple with the mobile computing device 62 to receive control signals therefrom.

By a first approach, the mobile computing device 62 includes the control circuit 56, power source 58, and memory 60. As such, the shelving unit 10 can advantageously have the light sources 52 mounted thereto and the other components of the electronic assembly 54 can be moved from unit 10 to unit 10. Pursuant to this approach, the interface 64 includes a connector or connectors 66 configured to couple or secure to the mobile computing device 62, such as a plug, adapter, or the like. If desired, the shelving unit 10 can include a cradle 68 adjacent to the interface 64 and connectors 66 so that a user can deposit the mobile computing device 62 in the cradle while the device 62 is connected to the interface 64. In one form, the connector 66 can be incorporated into the cradle 68 so that the device 62 can be coupled to the connector 66 by placing the device 62 into the cradle 68.

In some forms, the mobile computing device 62 receives a location of the shelving unit 10 from a location determination device 70 to thereby determine the correct modular and stocking information to utilize for the shelf heights. The location determination device 70 can take any suitable form, including gps circuitry in the device 62 or shelving unit 10, micro-locationing, light modulation, video analysis from electronic imagers in the store, selection of a user input 72 to identify the particular shelving unit 10, such as a touch screen, keypad, voice command, or the like, of the device 62, and so forth. In other forms, a user can enter the location of the shelving unit 10 into the mobile computing device 62.

After receiving the location of the shelving unit 10, the control circuit 56 accesses the modular and stocking information to determine where the shelves 32 are planned to be mounted to the back wall 14 and which pairs of mounting structures 28 correspond to the planned shelf heights. After identification of the planned mounting structures 28, the control circuit 56 provides power through the connectors 66 to the electronic components in the shelving unit 10 and sends a signal to the light sources 52 adjacent to each of the mounting structures 28 planned to have a shelf 32 mounted thereto. The signal can be sent automatically upon connection of the device 62 to the interface 64 or on command by selection of the user input 72. With the selected light sources 52 illuminated, the user can then easily mount the shelves 32 to the planned mounting structures 28 of the back wall 14. By a further approach, the user can connect the device 62 to the interface 64 to check the heights of shelves 32 already mounted to the back wall 14 by viewing the illuminated light sources 52 to make sure that the shelves 32 are mounted to the mounting structures 28 adjacent to the illuminated light sources 52.

By a second approach, the device 62 can wirelessly connect with the interface 64 over any suitable communication network 74, including WiFi, Bluetooth, near field communication, radio, and the like. In this approach, the shelving unit 10 includes the power source 58, such as by a battery or wired connection, so that the light sources 52 can be selectively illuminated. Further, the device 62 and interface 64 can include transceivers 76 to couple together or communicate therebetween. So configured, the device 62 determines a location of the shelving unit 10 with the location determination device 70, analyzes the modular and stocking information to determine planned shelf heights, and sends a signal to the interface 64 with instructions to illuminate the light sources 52 adjacent to the mounting structures 28 corresponding to the planned shelf heights.

In other embodiments, the shelving units 10 are configured to communicate with a central system 78 that includes the memory 60. The shelving unit 10 of this form includes the light sources 52, the power source 58, and the interface 64. The control circuit 56 can be incorporated into the shelving unit 10 and/or into the central system 78, as desired. By one approach, the central system 78 can be configured to send signals to individual ones of the shelving units 10 on command or periodically. As such, the central system 10 accesses the modular and stocking information for each shelving unit 10 and sends a signal to the interface 64 thereof to illuminate light sources 52 adjacent to the planned mounting structures 28. If desired, a user can utilize the device 62 or a user input 80 of the interface to instruct the central system 10 to illuminate the light sources 52 for a particular shelving unit 10. By another approach, the control circuit 56 of the shelving unit 10 can remotely access the modular and stocking information for the shelving unit 10 stored in the central system 78 and illuminate the light sources 52 adjacent to the planned mounting structures 28. As with the above form, the system 50 can operate on command, using the user input 80 or device 62, for example, or periodically.

In yet other embodiments, the shelving units 10 include the whole electronic assembly 54 such that a user can actuate a user input 80 of the interface 64 to selectively command the control circuit 56 to analyze the modular and stocking information and illuminate the light sources 52 adjacent to the mounting structures 28 planned to have shelves 32 mounted thereto. The shelving units 10 can further utilize the transceiver 76 to periodically access or receive updated modular and stocking information from the central system 78 and/or device 62. If desired, multiple shelving units 10 can be electrically connected to be powered by a single power source 58.

In some embodiments, a system for indicating shelf mounting height for a shelving unit is described herein that includes a shelving unit having a base, an upstanding wall secured to the base and having lateral edge portions; and mounting structures of the lateral edge portions spaced along a height thereof, pairs of the mounting structures configured to have a shelf mounted thereto to thereby mount the shelf to the upstanding wall. The system further includes light sources mounted to the upstanding wall adjacent to each pair of mounting structures; a power source configured to energize the light sources; and a control circuit in communication with the light sources. The control circuit is configured to: determine planned pairs of mounting structures intended to have shelves mounted thereto based on location and stocking information for the shelving unit; and illuminate the light sources adjacent to the planned pairs of mounting structures.

By several approaches, the system further includes a mobile computing device having the control circuit therein.

By some approaches, the system further includes an interface mounted to the shelving unit that is configured to have the mobile computing device connect thereto, where the interface is wired to the light sources. By further approaches, the interface includes connectors for physically coupling to the mobile computing device.

By several approaches, the system further includes a light assembly including an elongate member having the light sources mounted thereto, the elongate member configured to be mounted to the upstanding wall adjacent to the mounting structures.

In several embodiments, a method 100 is described herein for determining correct mounting height for shelves on a shelving unit including a base, an upstanding wall secured to the base and having lateral edge portions, mounting structures of the lateral edge portions spaced along a height thereof, pairs of the mounting structures configured to have a shelf mounted thereto to thereby mount the shelf to the upstanding wall, and light sources mounted to the upstanding wall adjacent to each pair of mounting structures. The method 100 includes: determining 102 with a control circuit planned pairs of the mounting structures intended to have shelves mounted thereto with a control circuit based on stocking information for the shelving unit; and illuminating 104 individual ones of the light sources that are mounted adjacent to the planned pairs of mounting structures.

By some approaches, the method 100 further includes providing 106 power to the light sources with a power source of a mobile computing device coupled to an interface of the shelving unit. By further approaches, the mobile computing device can include the control circuit; and wherein determining the planned pairs of the mounting structures includes the mobile computing device accessing the stocking information from a storage device thereof. By yet further approaches, the method 100 further includes determining 108 a location of the shelving unit with the mobile computing device.

In some embodiments, a method 200 is described herein for mounting shelves to a shelving unit including a base, an upstanding wall secured to the base and having lateral edge portions, mounting structures of the lateral edge portions spaced along a height thereof, and light sources mounted to the upstanding wall adjacent to each pair of mounting structures. The method 200 includes: determining 202 a pair of mounting structures of the mounting structures intended for having a shelf mounted thereto using location and stocking information for the shelving unit by illuminating a light source mounted to the upstanding wall adjacent to the pair of mounting structures; and mounting 204 a shelf to the pair of mounting structures.

By several approaches, the method 200 further includes connecting 206 a mobile computing device to an interface of the shelving unit electrically coupled to the light sources. By further approaches, connecting the mobile computing device can include physically coupling the mobile computing device to the interface. By yet further approaches, the method 200 further includes selecting 208 the shelving unit with a user input of the mobile computing device to thereby provide the location information.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for indicating shelf mounting height for a shelving unit, the system comprising:
a shelving unit including:
a base;
an upstanding wall secured to the base and having lateral edge portions;
mounting structures of the lateral edge portions spaced along a height thereof, pairs of the mounting structures configured to have a shelf mounted thereto to thereby mount the shelf to the upstanding wall;
light sources mounted to the upstanding wall adjacent to each pair of mounting structures;
a power source configured to energize the light sources; and
a control circuit in communication with the light sources; the control circuit configured to:
determine planned pairs of mounting structures intended to have shelves mounted thereto based on location and stocking information for the shelving unit; and
illuminate the light sources adjacent to the planned pairs of mounting structures.

2. The system of claim 1, wherein the mounting structures comprises notches.

3. The system of claim 1, wherein the light sources are mounted to the upstanding wall adjacent to each mounting structure.

4. The system of claim 1, further comprising a mobile computing device having the control circuit therein.

5. The system of claim 4, further comprising an interface mounted to the shelving unit and configured to have the mobile computing device connect thereto, the interface being wired to the light sources.

6. The system of claim 5, wherein the interface includes connectors for physically coupling to the mobile computing device.

7. The system of claim 6, wherein the mobile computing device includes the power source, the mobile computing device providing power to the light sources through the interface.

8. The system of claim 5, wherein the mobile computing device includes storage having the stocking information stored thereon.

9. The system of claim 5, wherein the mobile computing device is configured to determine a location of the shelving unit.

10. The system of claim 1, further comprising a database device having the stocking information stored thereon.

11. The system of claim 1, further comprising a light assembly including an elongate member having the light sources mounted thereto, the elongate member configured to be mounted to the upstanding wall adjacent to the mounting structures.

12. The system of claim 1, wherein the shelving unit includes the power source disposed therein and a receiver configured to receive signals from the control circuit.

13. A method for determining correct mounting height for shelves on a shelving unit including a base, an upstanding wall secured to the base and having lateral edge portions, mounting structures of the lateral edge portions spaced along a height thereof, pairs of the mounting structures configured to have a shelf mounted thereto to thereby mount the shelf to the upstanding wall, and light sources mounted to the upstanding wall adjacent to each pair of mounting structures, the method comprising:
determining with a control circuit planned pairs of the mounting structures intended to have shelves mounted thereto with a control circuit based on stocking information for the shelving unit; and
illuminating individual ones of the light sources that are mounted adjacent to the planned pairs of mounting structures.

14. The method of claim 13, further comprising providing power to the light sources with a power source of a mobile computing device coupled to an interface of the shelving unit.

15. The method of claim 14, wherein the mobile computing device includes the control circuit; and determining the planned pairs of the mounting structures comprises the mobile computing device accessing the stocking information from a storage device thereof.

16. The method of claim 15, further comprising determining a location of the shelving unit with the mobile computing device.

17. A method for mounting shelves to a shelving unit including a base, an upstanding wall secured to the base and having lateral edge portions, mounting structures of the lateral edge portions spaced along a height thereof, and light sources mounted to the upstanding wall adjacent to each pair of mounting structures the method comprising:
determining a pair of mounting structures of the mounting structures intended for having a shelf mounted thereto using location and stocking information for the shelving unit by illuminating a light source mounted to the upstanding wall adjacent to the pair of mounting structures; and
mounting a shelf to the pair of mounting structures.

18. The method of claim 17, further comprising connecting a mobile computing device to an interface of the shelving unit electrically coupled to the light sources.

19. The method of claim 18, wherein connecting the mobile computing device comprises physically coupling the mobile computing device to the interface.

20. The method of claim 19, further comprising selecting the shelving unit with a user input of the mobile computing device to thereby provide the location information.
